(19) United States
(12) Patent Application Publication
(10) Pub. No.: US 2025/0123492 A1
(43) Pub. Date: Apr. 17, 2025

(54) APPARATUS, SYSTEM, AND METHOD FOR REDUCING SPATIAL REQUIREMENTS OF CIRCUIT BOARDS EMBEDDED IN EYEWEAR DEVICES

(71) Applicant: Meta Platforms Technologies, LLC, Menlo Park, CA (US)

(72) Inventors: Peter Eli Renner, San Jose, CA (US); Umar Azad, San Jose, CA (US); Eswarappa Channabasappa, Milpitas, CA (US); Tao Zhou, San Jose, CA (US)

(21) Appl. No.: 18/542,838

(22) Filed: Dec. 18, 2023

Related U.S. Application Data
(60) Provisional application No. 63/590,300, filed on Oct. 13, 2023.

(51) Int. Cl. G02B 27/01; H01M 50/247; H01Q 1/27

(52) U.S. Cl. CPC G02B 27/0176; H01M 50/247; H01Q 1/273; G02B 2027/0178; H01M 2220/30

(57) ABSTRACT

An eyewear device for reducing the spatial requirements of embedded circuit boards may comprise (1) a temple that comprises an at least partial cavity, (2) a circuit board placed inside the at least partial cavity of the temple, and (3) at least one antenna that is (A) placed inside the at least partial cavity of the temple, (B) commutatively coupled to the circuit board, and (C) offset from the circuit board. Various other apparatuses, systems, and methods are also disclosed.

### CROSS REFERENCE TO RELATED APPLICATION

This application claims the benefit of U.S. Provisional Application No. 63/590,300 filed Oct. 13, 2023, the disclosure of which is incorporated in its entirety by this reference.

### BRIEF DESCRIPTION OF DRAWINGS

The accompanying drawings illustrate a number of example embodiments and are a part of the specification. Together with the following description, these drawings demonstrate and explain various principles of the instant disclosure.

FIG. 1 is an illustration of an exemplary eyewear device for reducing spatial requirements of circuit boards embedded in eyewear devices according to one or more implementations of this disclosure.

FIG. 2 is an illustration of an exemplary artificial-reality system for reducing spatial requirements of circuit boards embedded in eyewear devices according to one or more implementations of this disclosure.

FIG. 3 is an illustration of an exemplary implementation of an eyewear device for reducing spatial requirements of embedded circuit boards according to one or more embodiments of this disclosure.

FIG. 4 is an illustration of an exemplary eyewear device for reducing spatial requirements of embedded circuit boards according to one or more implementations of this disclosure.

FIG. 5 is an illustration of an exemplary eyewear device for reducing spatial requirements of embedded circuit boards according to one or more implementations of this disclosure.

FIG. 6 is an illustration of an exemplary eyewear device for reducing spatial requirements of embedded circuit boards according to one or more implementations of this disclosure.

FIG. 7 is an illustration of an exemplary eyewear device for reducing spatial requirements of embedded circuit boards according to one or more implementations of this disclosure.

FIG. 8 is an illustration of an exemplary eyewear device for reducing spatial requirements of embedded circuit boards according to one or more implementations of this disclosure.

FIG. 9 is an illustration of an exemplary eyewear device for reducing spatial requirements of embedded circuit boards according to one or more implementations of this disclosure.

FIG. 10 is a flow diagram of an exemplary method for reducing spatial requirements of circuit boards embedded in eyewear devices according to one or more implementations of this disclosure.

FIG. 11 is an illustration of exemplary augmented-reality glasses that may be used in connection with one or more implementations of this disclosure.

FIG. 12 is an illustration of an exemplary virtual-reality headset that may be used in connection with one or more implementations of this disclosure.

While the exemplary embodiments described herein are susceptible to various modifications and alternative forms, specific embodiments have been shown by way of example in the appendices and will be described in detail herein. However, the exemplary embodiments described herein are not intended to be limited to the particular forms disclosed. Rather, the instant disclosure covers all modifications, combinations, equivalents, and alternatives falling within this disclosure.

### DETAILED DESCRIPTION OF EXEMPLARY EMBODIMENTS

The present disclosure is generally directed to apparatuses, systems, and methods for reducing spatial requirements of circuit boards embedded in eyewear devices. As will be explained in greater detail below, these apparatuses, systems, and methods may provide numerous features and benefits.

In some examples, eyewear devices may facilitate, provide, and/or support artificial reality. Artificial reality may provide a rich, immersive experience in which users are able to interact with virtual objects and/or environments in one way or another. In this context, artificial reality may constitute and/or represent a form of reality that has been altered by virtual objects for presentation to a user. Such artificial reality may include and/or represent virtual reality (VR), augmented reality (AR), mixed reality, hybrid reality, or some combination and/or variation of one or more of the same.

The apparatuses, systems, and methods described herein may provide, facilitate, and/or represent a reduction in the spatial requirements of circuit boards (e.g., printed circuit boards) embedded in eyewear devices (e.g., smart glasses). As a specific example, one AR architecture may involve and/or represent a split configuration in which batteries and/or circuit boards are embedded in both temples and/or arms of a pair of smart glasses. For example, an AR architecture may include and/or represent one circuit board and one battery inside one temple and/or arm of the smart glasses and another circuit board and another battery inside the other temple and/or arm of the smart glasses. In this example, the AR architecture may facilitate and/or support multiple wireless technologies, such as WI-FI, BLUETOOTH, cellular, and/or global navigation satellite system (GNSS) communications.

In some examples, such wireless technologies may necessitate and/or rely on one or more antennas for the transmission and/or reception of wireless signals and/or communications. Conventional smart glasses often incorporate and/or contain circuit boards on which antennas are disposed and/or etched as conductive traces. In other words, the conductive traces disposed and/or etched on the circuit boards may serve and/or function as antennas for the wireless technologies. Unfortunately, the size, space, and/or area required to facilitate, sustain, and/or support such antennas on the circuit boards may be substantial and/or significant in the context of smart glasses. Accordingly, as demand for more compact and higher-performing smart glasses increases, AR equipment manufacturers may look to offload and/or transfer some components from the circuit boards to accommodate and/or make room for other components. Because other standalone antenna options are available, AR equipment manufacturers may opt to offload and/or transfer the antennas from the circuit boards to accommodate and/or make room for other components inside the smart glasses.

In some examples, one option for a standalone and/or separate antenna that supports certain wireless technology inside the smart glasses may include and/or represent a wire antenna and/or flex antenna that is communicatively coupled to but offset from the circuit board. In one example, a flex antenna may be fairly low-profile relative to the circuit board. For example, the flex antenna may sit and/or reside between 1 millimeter and 2 millimeters above the circuit board. In other words, the low-profile flex antenna may have a ground clearance of between 1 millimeter and 2 millimeters relative to the circuit board.

In some examples, the antenna may be adhered and/or secured to an inner wall of one of the temples and/or arms of the smart glasses. Additionally or alternatively, the antenna may be supported and/or secured by fasteners (such as spring clips and/or standoffs) that are coupled and/or attached to the circuit board. In one example, the antenna may be positioned and/or placed proximate to, above, and/or along a side, edge, and/or corner of the circuit board inside the temple and/or arm of the smart glasses.

In some examples, an antenna may cover and/or support all the WI-FI frequency bands. For example, an antenna may include and/or represent a high-band section and/or portion (e.g., 5, 6, and/or 7 gigahertz) and/or a low-band section and/or portion (e.g., 2.4 gigahertz). In one example, a low-band portion of the antenna may sit and/or reside above one edge of the circuit board inside the temple and/or arm of the smart glasses. In this example, a high-band portion of the antenna may sit and/or reside proximate and/or adjacent to the low-band portion of the antenna above the edge of the circuit board inside the temple and/or arm of the smart glasses. In certain implementations, a conductive connector may bridge across and/or communicatively couple the high-band portion and the low-band portion of the antenna.

In some examples, the antennas may be powered, energized, activated, and/or controlled by a radio frequency (RF) feed. For example, an RF feed may be communicatively coupled between the circuit board and a low-band antenna. Additionally or alternatively, another RF feed may be communicatively coupled between the circuit board and a high-band antenna.

In some examples, the antennas may be secured to and/or separated from the circuit board by one or more fasteners (such as spring clips and/or standoffs). For example, one or more spring clips may secure a low-band antenna and/or a high-band antenna to the circuit board while simultaneously offsetting the low-band and high-band antennas from the circuit board. In one example, one or more spring clips may support and/or be shared by both the low-band antenna and the high-band antenna. In certain implementations, the RF feeds for the low-band and high-band antennas may be positioned and/or placed proximate and/or adjacent to the spring clips.

As a specific example, one or more spring clips may be positioned and/or placed between a low-band antenna and a high-band antenna to facilitate supporting both the low-band and high-band antennas simultaneously. In this example, the one or more spring clips may be positioned and/or placed along one end of each of the low-band antenna and the high-band antenna. Additionally or alternatively, one or more additional spring clips may be positioned and/or placed along and/or at the other end of the high-band antenna. In certain implementations, the spring clips may serve and/or function as the shorting line for the low-band antenna and/or the high-band antenna.

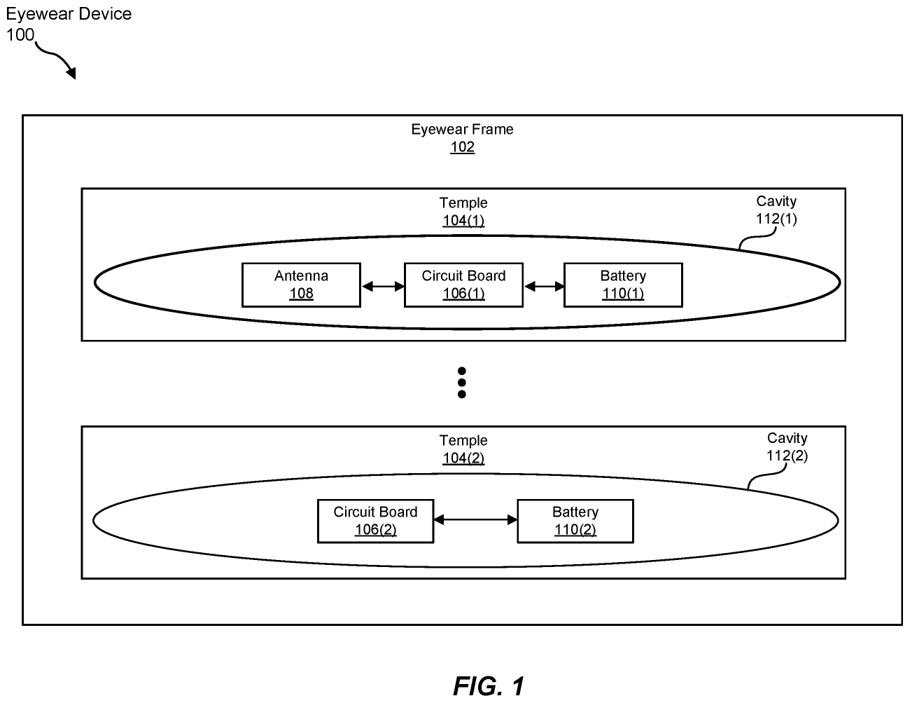

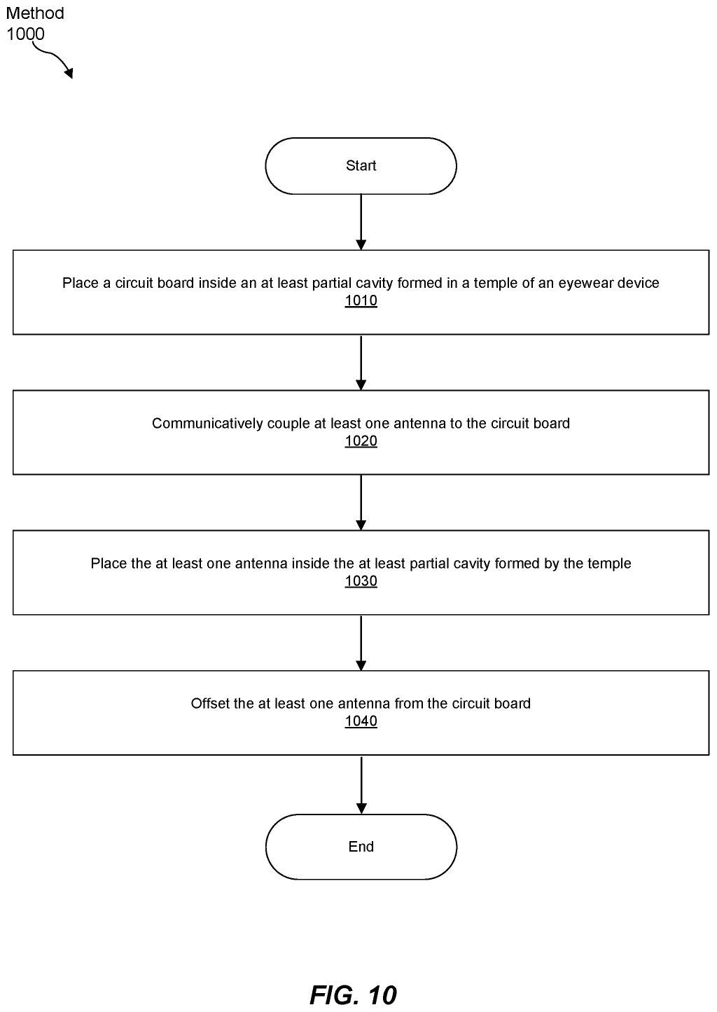

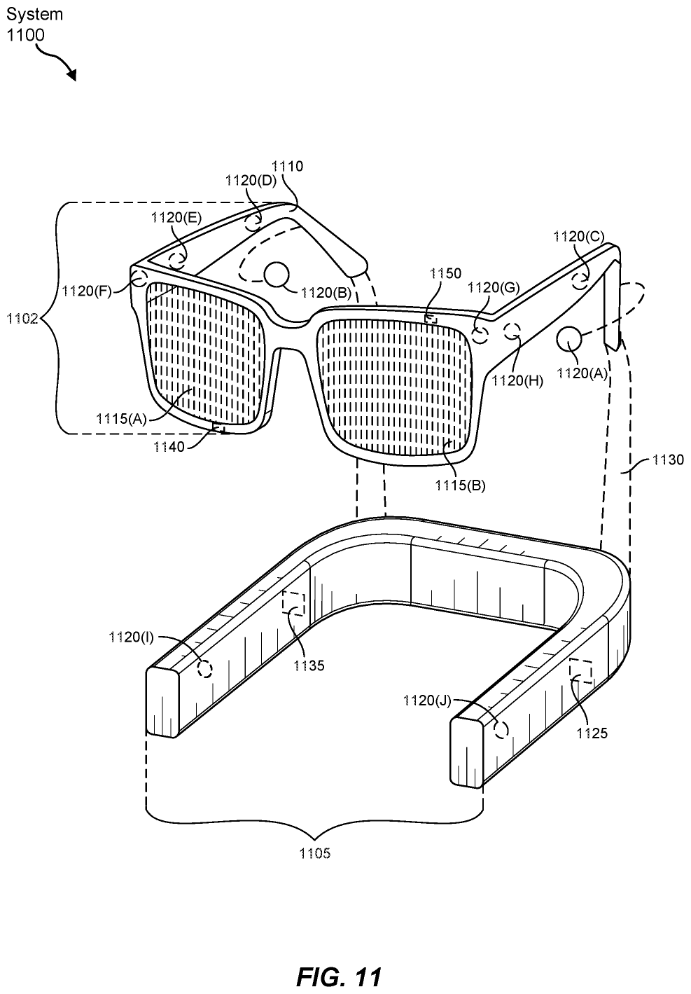

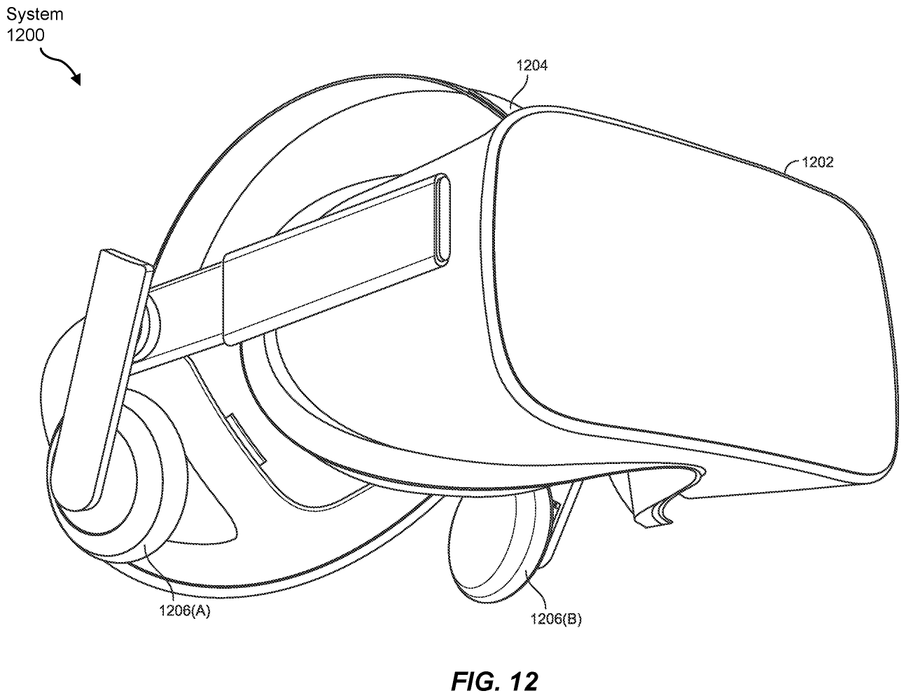

The following will provide, with reference to FIGS. 1-9, detailed descriptions of exemplary apparatuses, devices, systems, components, and corresponding configurations or implementations for reducing spatial requirements of circuit boards embedded in eyewear devices. In addition, detailed descriptions of methods for reducing spatial requirements of circuit boards embedded in eyewear devices will be provided in connection with FIG. 10. The discussion corresponding to FIGS. 11 and 12 will provide detailed descriptions of types of exemplary artificial-reality devices, wearables, and/or associated systems capable of reducing spatial requirements of embedded circuit boards.

FIG. 1 illustrates an exemplary eyewear device 100 for reducing spatial requirements of circuit boards embedded in eyewear devices. As illustrated in FIG. 1, eyewear device 100 may include and/or represent an eyewear frame 102 dimensioned to be worn by a user. In some examples, eyewear frame 102 may include and/or be equipped with temples 104(1) and 104(2). In one example, temple 104(1) may include and/or form an at least partial cavity 112(1), and/or temple 104(2) may include and/or form an at least partial cavity 112(2). In this example, temple 104(1) may include, constitute, and/or represent material that fully or partially surrounds and/or encompasses cavity 112(1), and/or temple 104(2) may include, constitute, and/or represent material that fully or partially surrounds and/or encompasses cavity 112(2).

In some examples, cavity 112(1) may constitute and/or represent empty space that is used to accommodate certain components, devices, and/or features of eyewear device 100 inside temple 104(1). Additionally or alternatively, cavity 112(2) may constitute and/or represent empty space that is used to accommodate certain components, devices, and/or features of eyewear device 100 inside temple 104(2).

In some examples, eyewear frame 102 may also include and/or be equipped circuit boards 106(1) and 106(2), an antenna 108, and/or batteries 110(1) and 110(2). In one example, circuit board 106(1) may be placed, positioned, and/or embedded inside cavity 112(1) of temple 104(1). Additionally or alternatively, circuit board 106(2) may be placed, positioned, and/or embedded inside cavity 112(2) of temple 104(2).

In some examples, antenna 108 may be placed, positioned, and/or embedded inside cavity 112(1) of temple 104(1). In one example, antenna 108 may be communicatively and/or electrically coupled or connected to circuit board 106(1). Additionally or alternatively, antenna 108 may be offset, spaced, and/or distanced from circuit board 106(1).

In some examples, eyewear device 100 may include and/or represent a head-mounted display (HMD). In one example, an HMD may include and/or represent any type or form of display device or system that is worn on or about the user's face and displays virtual content, such as computer-generated objects and/or AR content, to the user. HMDs may present and/or display content in any suitable way, including via a display screen, a liquid crystal display (LCD), a light-emitting diode (LED), a microLED display, a plasma display, a projector, a cathode ray tube, an optical mixer, combinations or variations of one or more of the same. HMDs may present and/or display content in one or more media formats. For example, HMDs may display video, photos, computer-generated imagery (CGI), and/or variations or combinations of one or more of the same. Additionally or alternatively, HMDs may include and/or incorporate see-through lenses that enable the user to see the user's surroundings in addition to such computer-generated content.

HMDs may provide diverse and/or distinctive user experiences. Some HMDs may provide virtual-reality experiences (i.e., they may display computer-generated or pre-recorded content), while other HMDs may provide real-world experiences (i.e., they may display live imagery from the physical world). HMDs may also provide any mixture of live and virtual content. For example, virtual content may be projected onto the physical world (e.g., via optical or video see-through lenses), which may result in AR and/or mixed-reality experiences.

In some examples, circuit boards 106(1) and 106(2) may each include and/or represent a wafer of semiconductor materials (such as silicon, germanium, and/or gallium arsenide). In one example, circuit boards 106(1) and 106(2) may each include and/or represent a wafer of electrical insulator materials (such as silicon dioxide, sapphire, aluminum oxide, polymers, and/or ceramics). Additionally or alternatively, circuit boards 106(1) and 106(2) may each include and/or represent multiple layers of insulation materials.

In some examples, circuit boards 106(1) and 106(2) may each include and/or contain conductive traces and/or through-silicon vias that carry and/or route signals across and/or throughout the silicon. Although not necessarily illustrated and/or labelled in this way in FIG. 1, one or more of circuit boards 106(1) and 106(2) may include and/or represent one or more additional components, devices, and/or features that form part of one or more circuits incorporated in eyewear device 100. For example, circuit boards 106(1) and 106(2) may each include, contain, and/or represent certain electrical and/or electronic components or devices that enable eyewear device 100 to produce and/or provide artificial-reality experiences for the user.

In some examples, one or more of batteries 110(1) and 110(2) may power, energize, and/or support the operation of eyewear device 100 for the user. For example, batteries 110(1) and 110(2) may power, energize, and/or support circuitry on circuit boards 106(1) and 106(2), respectively. Batteries 110(1) and 110(2) may include and/or represent any type or form of portable electric power source. In one example, batteries 110(1) and 110(2) may include and/or represent electrochemical cells capable of sourcing and/or providing electric power or current to one or more circuits and/or devices disposed on circuit boards 106(1) and 106(2), respectively. Examples of batteries 110(1) and 110(2) include, without limitation, lithium-ion batteries, lithium-polymer batteries, primary lithium batteries, alkaline batteries, aluminum-ion batteries, rechargeable batteries, primary cell batteries, secondary cell batteries, flow batteries, metal-air batteries, nickel-cadmium batteries, nickel-metal hydride batteries, combinations or variations of one or more of the same, and/or any other suitable type of batteries.

In some examples, antenna 108 may include and/or represent any type or form of device and/or interface that facilitates and/or supports the propagation of radio waves between metal conductors and/or space (e.g., air). In one example, antenna 108 may include and/or represent part of at least one radio that transmits and/or receives communications via space. In this example, the radio may also include and/or represent various other components, such as RF circuitry.

In some examples, antenna 108 may include and/or represent a standalone antenna that is separate and/or distinct from circuit board 106(1). In one example, antenna 108 may include and/or represent a wire antenna, a flex antenna, and a WI-FI 6e antenna that is communicatively coupled to but offset from circuit board 106(1). Additionally or alternatively, antenna 108 may be fairly low-profile relative to circuit board 106(1). For example, antenna 108 may sit and/or reside between 1 millimeter and 2 millimeters above circuit board 106(1) within cavity 112(1). In other words, antenna 108 may have a ground clearance of between 1 millimeter and 2 millimeters relative to circuit board 106(1) within cavity 112(1).

In some examples, antenna 108 may include and/or represent any type or form of material and/or substance capable of radiating RF energy for transmitting and/or receiving RF communications. Examples of materials used to form antenna 108 include, without limitation, magnesiums, coppers, aluminums, steels, stainless steels, silvers, golds, combinations or variations of one or more of the same, and/or any other suitable materials. In certain implementations, the wireless technologies supported by antenna 108 and/or the RF circuitry may direct, influence, and/or control certain features (e.g., virtual features, dimming features, audio features, etc.) of eyewear device 100 in connection with the user's experience.

In some examples, the RF circuitry may include and/or represent one or more circuits designed to produce, carry, transmit, receive, process, and/or otherwise use wireless signals within the RF band and/or spectrum. For example, the RF circuitry may include and/or represent all or a portion of an RF integrated circuit (RFIC) incorporated in eyewear device 100. In this example, the RFIC may contain and/or implement various components that support and/or facilitate RF communications via antenna 108. Examples of such RF components include, without limitation, signal generators, filters, transmission lines, waveguides, radios, mixers, amplifiers, oscillators, couplers, detectors, combiners, receivers, transmitters, transceivers, tuners, modulators, demodulators, shielding, circuit boards, transistors, processors, resistors, capacitors, diodes, inductors, switches, registers, flipflops, connections, ports, antenna ports, RF frontends, portions of one or more of the same, combinations or variations of one or more of the same, and/or any other suitable components.

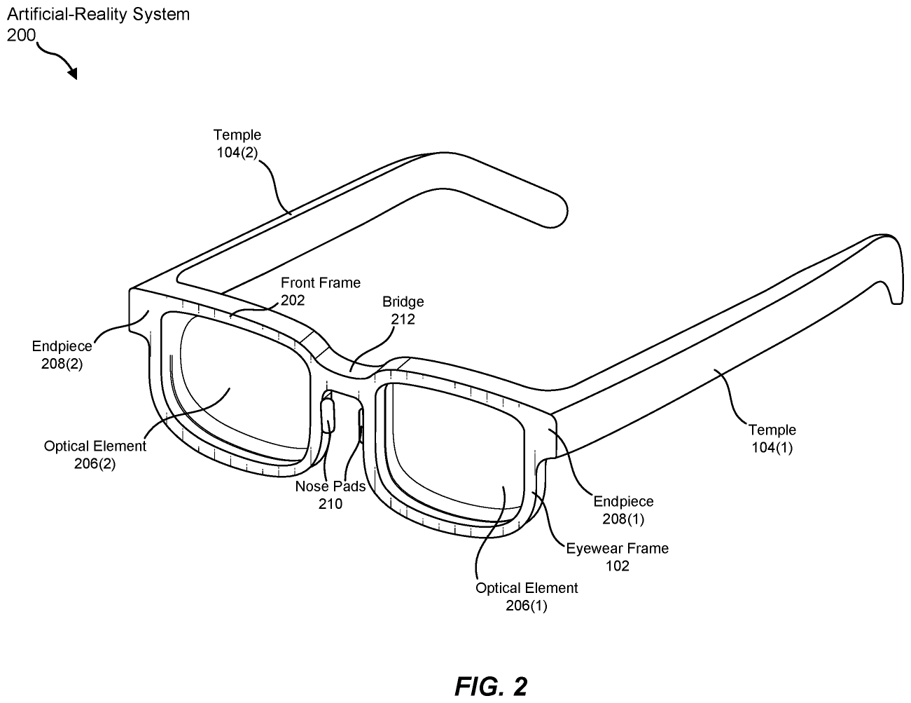

FIG. 2 illustrates an exemplary artificial-reality system 200 for reducing spatial requirements of circuit boards embedded in an eyewear device. In some examples, artificial-reality system 200 may include and/or represent certain components and/or features that perform and/or provide functionalities that are similar and/or identical to those described above in connection with FIG. 1. As illustrated in FIG. 2, artificial-reality system 200 may include and/or represent eyewear frame 102 that facilitates, supports, and/or provides artificial-reality experiences for a user. In one example, eyewear frame 102 may include and/or represent a front frame 202, temples 104(1) and 104(2), optical elements 206(1) and 206(2), endpieces 208(1) and 208(2), nose pads 210, and/or a bridge 212.

In some examples, optical elements 206(1) and 206(2) may be inserted and/or installed in front frame 202. In other words, optical elements 206(1) and 206(2) may be coupled to, incorporated in, and/or held by eyewear frame 102. In one example, optical elements 206(1) and 206(2) may be configured and/or arranged to provide one or more virtual features for presentation to a user wearing artificial-reality system 200. These virtual features may be driven, influenced, and/or controlled by one or more wireless technologies supported by artificial-reality system 200.

In some examples, optical elements 206(1) and 206(2) may each include and/or represent optical stacks, lenses, and/or films. In one example, optical elements 206(1) and 206(2) may each include and/or represent various layers that facilitate and/or support the presentation of virtual features and/or elements that overlay real-world features and/or elements. Additionally or alternatively, optical elements 206(1) and 206(2) may each include and/or represent one or more screens, lenses, and/or fully or partially see-through components. Examples of optical elements 206(1) and (2) include, without limitation, electrochromic layers, dimming stacks, transparent conductive layers (such as indium tin oxide films), metal meshes, antennas, transparent resin layers, lenses, films, combinations or variations of one or more of the same, and/or any other suitable optical elements.

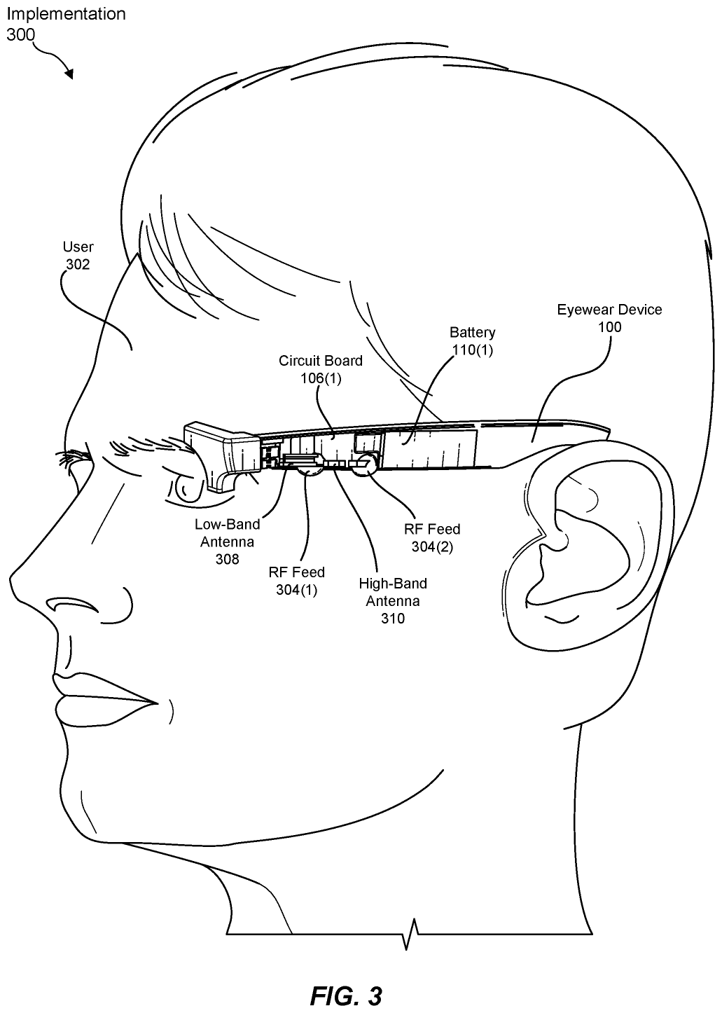

FIG. 3 illustrates an exemplary implementation 300 in which a portion of eyewear device 100 is applied to and/or residing on the face of a user 302. In some examples, implementation 300 may include and/or involve certain components and/or features that perform and/or provide functionalities that are similar and/or identical to those described above in connection with either FIG. 1 or FIG. 2. As illustrated in FIG. 3, implementation 300 may show and/or represent a see-though illustration of a portion of eyewear device 100 donned by user 302. In one example, implementation 300 may omit, exclude, and/or obfuscate the external wall and/or material of temple 104(1) for the purpose of exposing the components and/or devices embedded and/or placed inside cavity 112(1).

In some examples, antenna 108 may include and/or represent both a high-band portion and/or section and a low-band portion and/or section. For example, antenna 108 may include and/or represent a high-band antenna 310 and a low-band antenna 308. In one example, the combination of high-band antenna 310 and low-band antenna 308 may cover and/or support all the WI-FI frequency bands. For example, high-band antenna 310 may cover and/or support frequencies in the 5, 6, and/or 7 gigahertz bands and/or ranges. Additionally or alternatively, low-band antenna 308 may cover and/or support frequencies in the 2.4 gigahertz band and/or range.

In some examples, low-band antenna 308 may sit, reside, and/or be positioned above one edge (e.g., the lower edge illustrated in FIG. 3) of circuit board 106(1) inside temple 104(1) of eyewear frame 102. In one example, high-band antenna 310 may sit, reside, and/or be positioned proximate and/or adjacent to low-band antenna 308 above the same edge of circuit board 106(1) inside temple 104(1) of eyewear frame 102. In certain implementations, a conductive connector may bridge across and/or communicatively couple high-band antenna 310 and low-band antenna 308 to one another.

In some examples, eyewear device 100 may include and/or represent an RF feed 304(2) that is electrically and/or communicatively coupled between high-band antenna 310 and circuit board 106(1). Additionally or alternatively, eyewear device 100 may include and/or represent an RF feed 304(1) that is electrically and/or communicatively coupled between low-band antenna 308 and circuit board 106(1). In one example, RF feeds 304(1) and 304(2) may facilitate and/or provide connectivity or continuity between RF circuitry and low-band antenna 308 and high-band antenna 310, respectively.

In some examples, RF feed 304(1) may be placed and/or positioned proximate and/or adjacent to a fastener that extends between low-band antenna 308 and circuit board 106(1). Additionally or alternatively, RF feed 304(2) may be placed and/or positioned proximate and/or adjacent to another fastener that extends between high-band antenna 310 and circuit board 106(1).

In some examples, although certain descriptions provided herein may reference components and/or features of eyewear device 100 from one side (e.g., from one temple but not necessarily the other), the same descriptions may apply with equal effect to the other side. For example, certain illustrations and/or descriptions may refer to the structure, contents, and/or functionality of temple 104(1) without necessarily referencing temple 104(2). Such illustrations and/or descriptions may also apply and/or correspond to temple 104(2). In other words, temple 104(2) may include and/or represent similar and/or identical structure, contents, and/or functionality as temple 104(1).

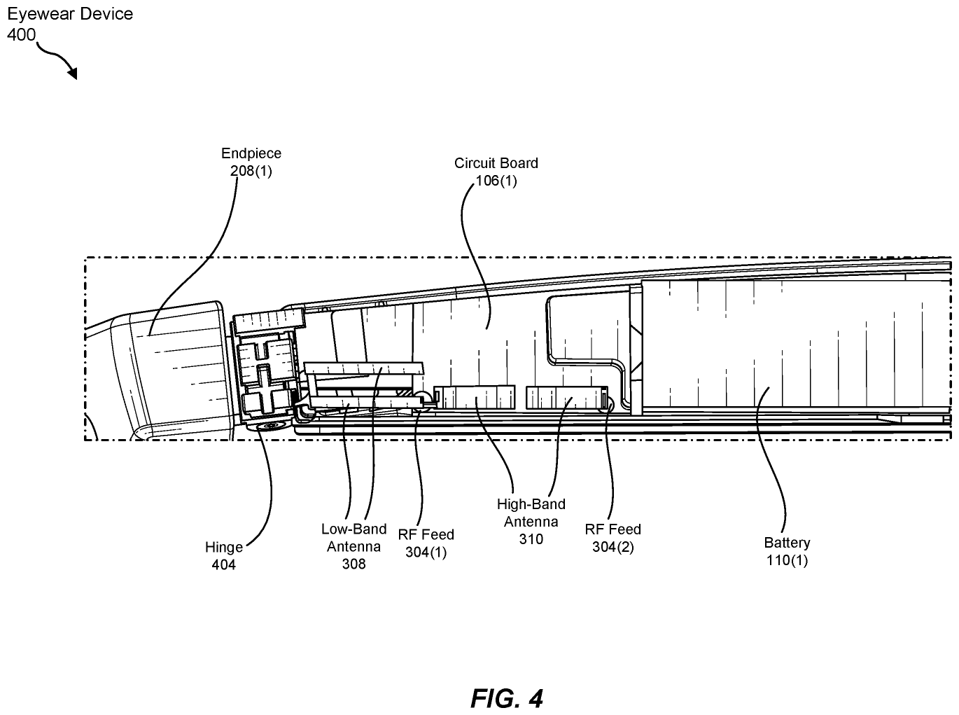

FIG. 4 illustrates a portion of an exemplary eyewear device 400 that facilitates and/or supports reducing spatial requirements of embedded circuit boards. In some examples, eyewear device 400 may include and/or represent certain components and/or features that perform and/or provide functionalities that are similar and/or identical to those described above in connection with any of FIGS. 1-3. As illustrated in FIG. 4, exemplary eyewear device 400 may include and/or represent temple 104(1) movably coupled to endpiece 208(1) via a hinge 404.

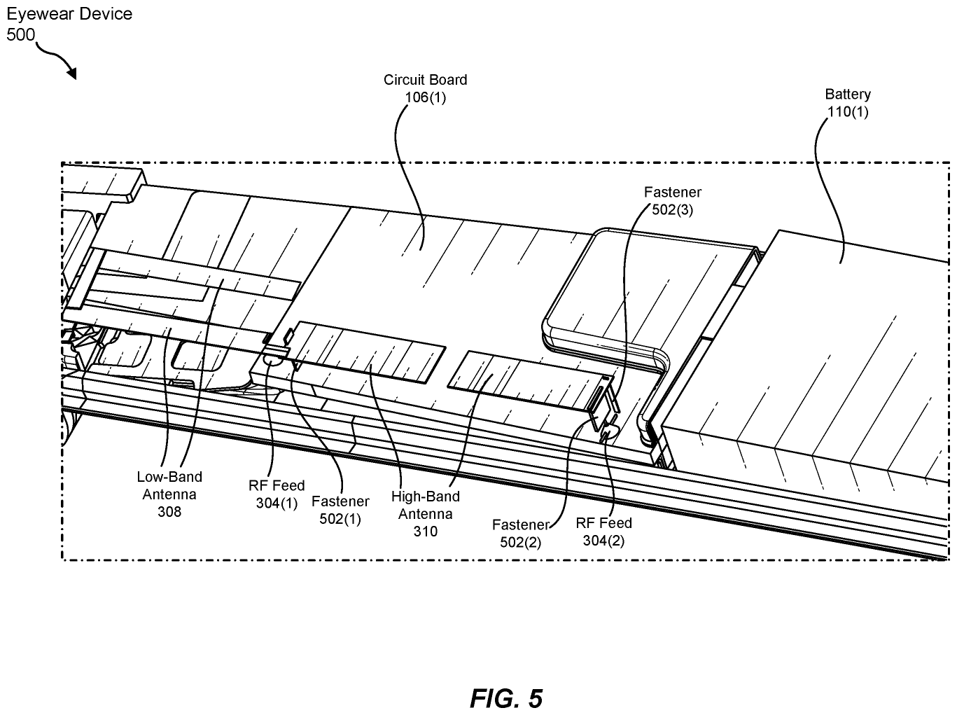

FIG. 5 illustrates a portion of an exemplary eyewear device 500 that facilitates and/or supports reducing spatial requirements of embedded circuit boards. In some examples, eyewear device 500 may include and/or represent certain components and/or features that perform and/or provide functionalities that are similar and/or identical to those described above in connection with any of FIGS. 1-4. As illustrated in FIG. 5, low-band antenna 308 may be coupled, secured, and/or fixed to circuit board 106(1) via a fastener 502(1). Additionally or alternatively, high-band antenna 310 may be coupled, secured, and/or fixed to circuit board 106(1) via a fastener 502(2) and/or a fastener 502(3).

In some examples, fasteners 502(1)-(3) may include and/or represent spring clips and/or standoffs that space and/or offset low-band antenna 308 and high-band antenna 310, respectively, from circuit board 106(1). In one example, fastener 502(1) may function and/or serve as a shorting line for low-band antenna 308, and/or fastener 502(2) or 502(3) may function and/or serve as a shorting line for high-band antenna 310. For example, fastener 502(1) may effectively short low-band antenna 308 to an electrical ground of circuit board 106(1), and/or fastener 502(2) or 502(3) may effectively short high-band antenna 310 to the electrical ground of circuit board 106(1).

In some examples, one or more of fasteners 502(1)-(3) may secure, offset, and/or support both low-band antenna 308 and high-band antenna 310 simultaneously. For example, fastener 502(1) may secure, offset, and/or support one side of low-band antenna 308 and one side of high-band antenna 310 at the same time. Additionally or alternatively, one or more of fasteners 502(2) and 502(3) may secure, offset, and/or support the other side of high-band antenna 310.

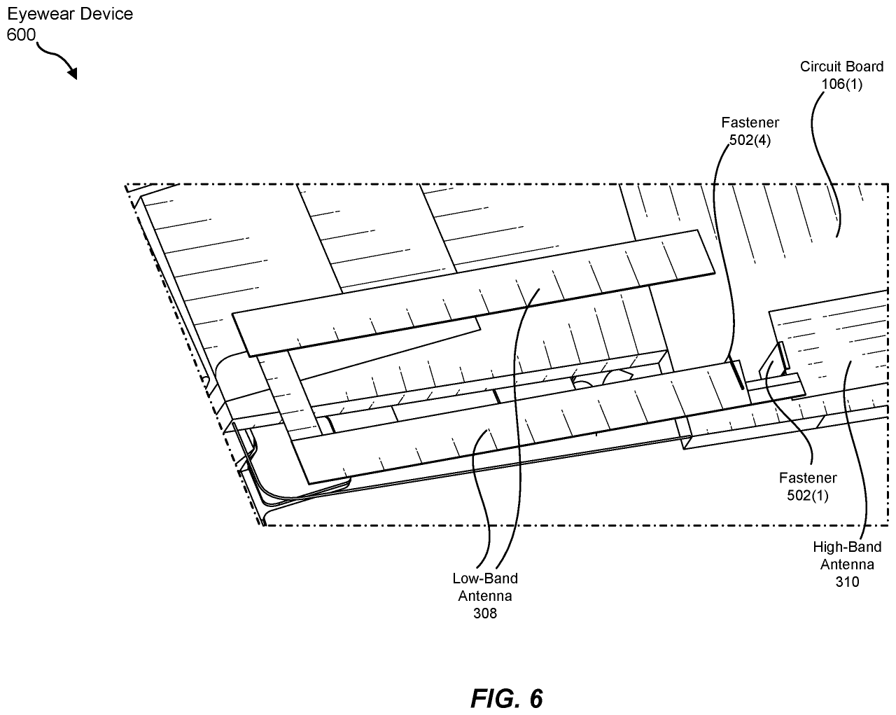

FIG. 6 illustrates a portion of an exemplary eyewear device 600 that facilitates and/or supports reducing spatial requirements of embedded circuit boards. In some examples, eyewear device 600 may include and/or represent certain components and/or features that perform and/or provide functionalities that are similar and/or identical to those described above in connection with any of FIGS. 1-5. As illustrated in FIG. 6, low-band antenna 308 may be coupled, secured, and/or fixed to circuit board 106(1) at least in part via a fastener 502(4). Additionally or alternatively, high-band antenna 310 may be coupled, secured, and/or fixed to circuit board 106(1) at least in part via a fastener 502(1).

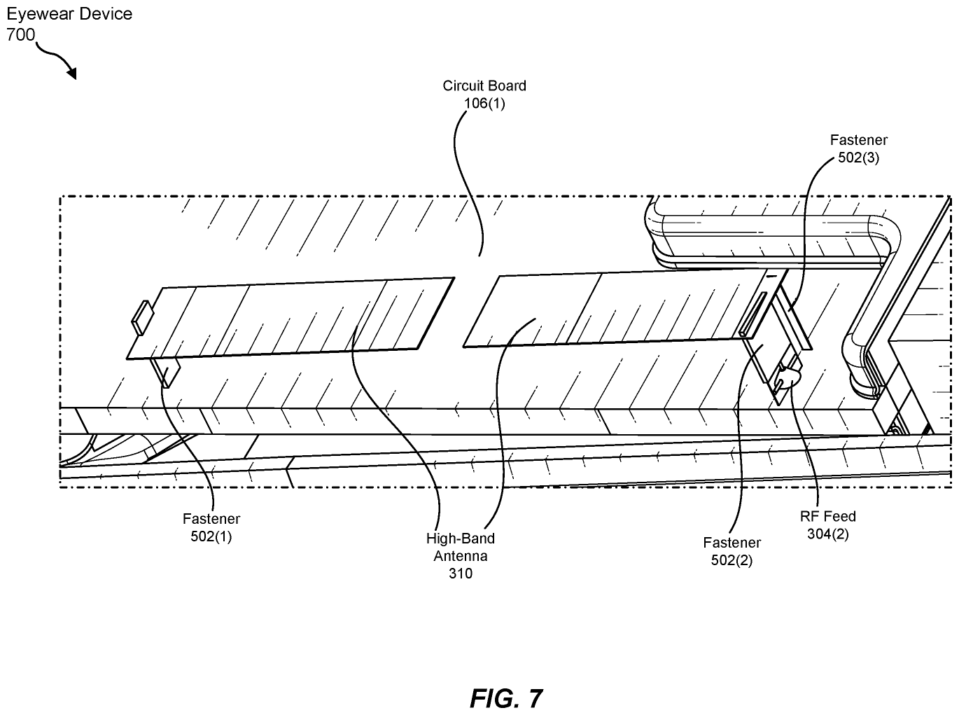

FIG. 7 illustrates a portion of an exemplary eyewear device 700 that facilitates and/or supports reducing spatial requirements of embedded circuit boards. In some examples, eyewear device 700 may include and/or represent certain components and/or features that perform and/or provide functionalities that are similar and/or identical to those described above in connection with any of FIGS. 1-6. As illustrated in FIG. 7, high-band antenna 310 may be coupled, secured, and/or fixed to circuit board 106(1) via one or more of fasteners 502(1)-(3).

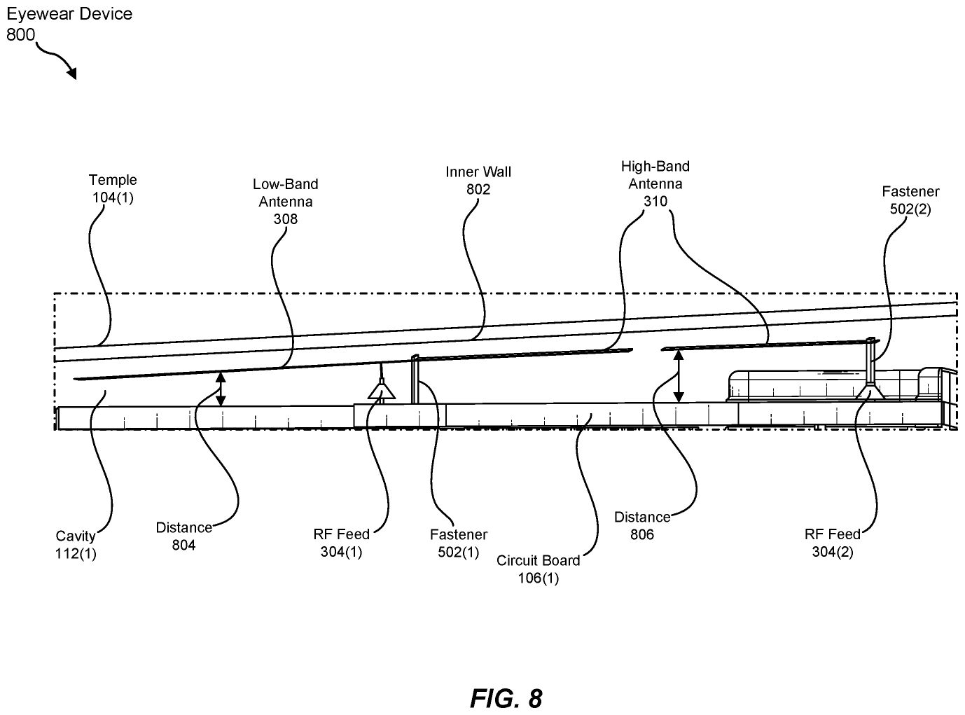

FIG. 8 illustrates a portion of an exemplary eyewear device 800 that facilitates and/or supports reducing spatial requirements of embedded circuit boards. In some examples, eyewear device 800 may include and/or represent certain components and/or features that perform and/or provide functionalities that are similar and/or identical to those described above in connection with any of FIGS. 1-7. As illustrated in FIG. 8, low-band antenna 308 may be offset, spaced, and/or distanced from circuit board 106(1) by a clearance 804. Additionally or alternatively, high-band antenna 310 may be offset, spaced, and/or distanced from circuit board 106(1) by a clearance 806.

In some examples, clearance 804 may constitute and/or represent an approximate distance of between 1 millimeter and 2 millimeters above circuit board 106(1) within cavity 112(1). Additionally or alternatively, clearance 806 may constitute and/or represent an approximate distance of between 1 millimeter and 2 millimeters above circuit board 106(1) within cavity 112(1).

In some examples, temple 104(1) of eyewear device 800 may include and/or represent an inner wall 802. In one example, inner wall 802 may include and/or represent material that covers, surrounds, and/or enshrouds at least some of the components and/or features embedded inside cavity 112(1) of temple 104(1). In certain implementations, low-band antenna 308 and/or high-band antenna 310 may be coupled, secured, and/or fixed to inner wall 802 of temple 104(1). For example, low-band antenna 308 and/or high-band antenna 310 may be coupled, secured, and/or fixed to inner wall 802 of temple 104(1) via one or more fasteners and/or adhesives. Examples of such adhesives include, without limitation, epoxies, glues, silicones, combinations or variations of one or more of the same, and/or any other suitable adhesives.

In some examples, low-band antenna 308 and/or high-band antenna 310 may be physically coupled, secured, and/or fixed to both circuit board 106(1) and inner wall 802 simultaneously. Additionally or alternatively, low-band antenna 308 and/or high-band antenna 310 may be physically coupled, secured, and/or fixed to either circuit board 106(1) or inner wall 802.

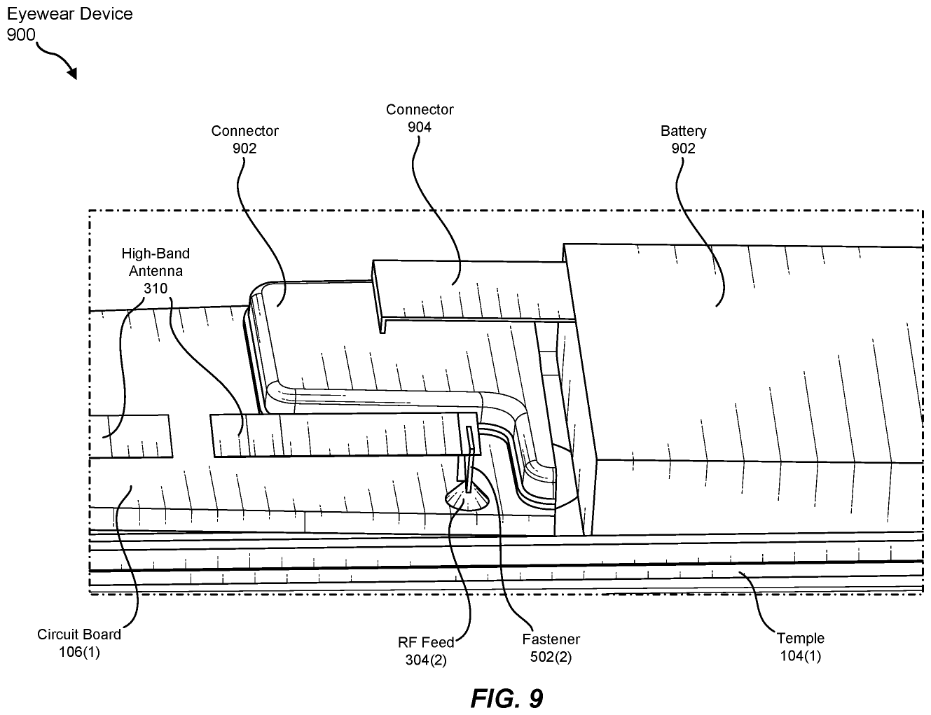

FIG. 9 illustrates a portion of an exemplary eyewear device 900 that facilitates and/or supports reducing spatial requirements of embedded circuit boards. In some examples, eyewear device 900 may include and/or represent certain components and/or features that perform and/or provide functionalities that are similar and/or identical to those described above in connection with any of FIGS. 1-8. As illustrated in FIG. 9, eyewear device 900 may include and/or contain connectors 902 and 904 that communicatively and/or electrically couple battery 110(1) and circuit board 106(1) to one another within cavity 112(1) of temple 104(1). In one example, connectors 902 and 904 may enable battery 110(1) to provide, source, and/or deliver power and/or electric current to circuit board 106(1). In this example, the power and/or electric current provided, sourced, and/or delivered by battery 110(1) may energize one or more components and/or features disposed on circuit board 106(1) and/or circuit board 106(2).

In some examples, the various devices and systems described in connection with FIGS. 1-9 may include and/or represent one or more additional circuits, components, and/or features that are not necessarily illustrated and/or labeled in FIGS. 1-9. For example, eyewear device 100 may also include and/or represent additional analog and/or digital circuitry, onboard logic, transistors, RF transmitters, RF receivers, transceivers, antennas, resistors, capacitors, diodes, inductors, switches, registers, flipflops, connections, traces, buses, semiconductor (e.g., silicon) devices and/or structures, processing devices, storage devices, circuit boards, sensors, packages, substrates, housings, combinations or variations of one or more of the same, and/or any other suitable components. In certain implementations, one or more of these additional circuits, components, and/or features may be inserted and/or applied between any of the existing circuits, components, and/or features illustrated in FIGS. 1-9 consistent with the aims and/or objectives described herein. Accordingly, the electrical and/or communicative couplings described with reference to FIGS. 1-9 may be direct connections with no intermediate components, devices, and/or nodes or indirect connections with one or more intermediate components, devices, and/or nodes.

In some examples, the phrase “to couple” and/or the term “coupling”, as used herein, may refer to a direct connection and/or an indirect connection. For example, a direct coupling between two components may constitute and/or represent a coupling in which those two components are directly connected to each other by a single node that provides electrical continuity from one of those two components to the other. In other words, the direct coupling may exclude and/or omit any additional components between those two components.

Additionally or alternatively, an indirect coupling between two components may constitute and/or represent a coupling in which those two components are indirectly connected to each other by multiple nodes that fail to provide electrical continuity from one of those two components to the other. In other words, the indirect coupling may include and/or incorporate at least one additional component between those two components.

FIG. 10 is a flow diagram of an exemplary method 1000 for configuring, assembling, and/or manufacturing eyewear devices whose circuit boards have reduced spatial requirements. In one example, the steps shown in FIG. 10 may be achieved and/or accomplished by a computing equipment manufacturer or subcontractor that manufactures and/or produces HMDs for AR experiences. Additionally or alternatively, the steps shown in FIG. 10 may incorporate and/or involve certain sub-steps and/or variations consistent with the descriptions provided above in connection with FIGS. 1-9.

As illustrated in FIG. 10, method 1000 may include the step of placing a circuit board inside an at least partial cavity formed in a temple of an eyewear device (1010). Step 1010 may be performed in a variety of ways, including any of those described above in connection with FIGS. 1-9. For example, an AR equipment manufacturer or subcontractor may place, position, and/or embed a circuit board inside an at least partial cavity formed in a temple of an eyewear device.

Method 1000 may also include the step of communicatively coupling at least one antenna to the circuit board (1020). Step 1020 may be performed in a variety of ways, including any of those described above in connection with FIGS. 1-9. For example, the AR equipment manufacturer or subcontractor may communicatively and/or electrically couple at least one antenna to the circuit board.

Method 1000 may further include the step of placing the at least one antenna inside the at least partial cavity formed in the temple (1030). Step 1030 may be performed in a variety of ways, including any of those described above in connection with FIGS. 1-9. For example, the AR equipment manufacturer or subcontractor may place, position, and/or embed the at least one antenna inside the at least partial cavity formed in the temple.

Method 1000 may further include the step of offsetting the at least one antenna from the circuit board (1040). Step 1040 may be performed in a variety of ways, including any of those described above in connection with FIGS. 1-9. For example, the AR equipment manufacturer or subcontractor may offset, raise, and/or space the at least one antenna from the circuit board.

### EXAMPLE EMBODIMENTS

Example 1: An eyewear device comprising (1) a temple that comprises an at least partial cavity, (2) a circuit board placed inside the at least partial cavity of the temple, and (3) at least one antenna that is (A) placed inside the at least partial cavity of the temple, (B) commutatively coupled to the circuit board, and (C) offset from the circuit board.

Example 2: The eyewear device of Example 1, wherein the at least one antenna comprises a high-band antenna and a low-band antenna that are secured to circuit board by one or more fasteners

Example 3: The eyewear device of either Example 1 or Example 2, wherein the one or more fasteners comprise one or more spring clips that serve as one or more shorting lines for the high-band antenna or the low-band antenna.

Example 4: The eyewear device of any of Examples 1-3, wherein the one or more fasteners comprise a spring clip that supports both the high-band antenna and the low-band antenna simultaneously.

Example 5: The eyewear device of any of Examples 1-4, further comprising (1) a radio-frequency feed communicatively coupled between the high-band antenna and the circuit board and (2) an additional radio-frequency feed communicatively coupled between the low-band antenna and the circuit board.

Example 6: The eyewear device of any of Examples 1-5, wherein the radio-frequency feed or the additional radio-frequency feed is positioned proximate to the one or more fasteners.

Example 7: The eyewear device of any of Examples 1-6, further comprising (1) a plurality of batteries and (2) an additional temple that comprises at least a partial cavity, wherein one of the plurality of batteries is placed inside the at least partial cavity of the temple and another one of the plurality of batteries is placed inside the at least partial cavity of the additional temple.

Example 8: The eyewear device of any of Examples 1-7, further comprising an additional circuit board that is placed inside the at least partial cavity of the additional temple.

Example 9: The eyewear device of any of Examples 1-8, wherein the at least one antenna comprises at least one flex antenna.

Example 10: The eyewear device of any of Examples 1-9, wherein the at least one antenna is offset from the circuit board by a distance of between one millimeter and two millimeters.

Example 11: The eyewear device of any of Examples 1-10, wherein the at least one antenna is secured to an inner wall of the temple.

Example 12: The eyewear device of any of Examples 1-11, wherein the at least one antenna supports a 2.4 gigahertz band, a 5 gigahertz band, a 6 gigahertz band, and/or a 7 gigahertz band.

Example 13: An artificial-reality system comprising (1) a temple of an eyewear frame that comprises an at least partial cavity, (2) a circuit board placed inside the at least partial cavity of the temple, (3) at least one antenna that is (A) placed inside the at least partial cavity of the temple, (B) commutatively coupled to the circuit board, and (C) offset from the circuit board, and (4) at least one see-through optical element that facilitates viewing both a physical environment of a user and a virtual object.

Example 14: The artificial-reality system of Example 13, wherein the at least one antenna comprises a high-band antenna and a low-band antenna that are secured to circuit board by one or more fasteners.

Example 15: The artificial-reality system of Example 13 or Example 14, wherein the one or more fasteners comprise one or more spring clips that serve as one or more shorting lines for the high-band antenna or the low-band antenna.

Example 16: The artificial-reality system of any of Examples 13-15, wherein the one or more fasteners comprise a spring clip that supports both the high-band antenna and the low-band antenna simultaneously.

Example 17: The artificial-reality system of any of Examples 13-16, further comprising (1) a radio-frequency feed communicatively coupled between the high-band antenna and the circuit board and (2) an additional radio-frequency feed communicatively coupled between the low-band antenna and the circuit board.

Example 18: The artificial-reality system of any of Examples 13-17, wherein the radio-frequency feed or the additional radio-frequency feed is positioned proximate to the one or more fasteners.

Example 19: The artificial-reality system of any of Examples 13-18, further comprising (1) a plurality of batteries and (2) an additional temple that comprises at least a partial cavity, wherein one of the plurality of batteries is placed inside the at least partial cavity of the temple and another one of the plurality of batteries is placed inside the at least partial cavity of the additional temple.

Example 20: A method comprising (1) placing a circuit board inside an at least partial cavity formed in a temple of an eyewear device, (2) communicatively coupling at least one antenna to the circuit board, (3) placing the at least one antenna inside the at least partial cavity formed in the temple, and (4) offsetting the at least one antenna from the circuit board.

Embodiments of the present disclosure may include or be implemented in conjunction with various types of artificial-reality systems. Artificial reality is a form of reality that has been adjusted in some manner before presentation to a user, which may include, for example, a VR, an AR, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a 3D effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

Artificial-reality systems may be implemented in a variety of different form factors and configurations. Some artificial-reality systems may be designed to work without near-eye displays (NEDs). Other artificial-reality systems may include an NED that also provides visibility into the real world (such as, e.g., augmented-reality system 1100 in FIG. 11) or that visually immerses a user in an artificial reality (such as, e.g., virtual-reality system 1200 in FIG. 12). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 11, augmented-reality system 1100 may include an eyewear device 1102 with a frame 1110 configured to hold a left display device 1115(A) and a right display device 1115(B) in front of a user's eyes. Display devices 1115(A) and 1115(B) may act together or independently to present an image or series of images to a user. While augmented-reality system 1100 includes two displays, embodiments of this disclosure may be implemented in augmented-reality systems with a single NED or more than two NEDs.

In some embodiments, augmented-reality system 1100 may include one or more sensors, such as sensor 1140. Sensor 1140 may generate measurement signals in response to motion of augmented-reality system 1100 and may be located on substantially any portion of frame 1110. Sensor 1140 may represent one or more of a variety of different sensing mechanisms, such as a position sensor, an inertial measurement unit (IMU), a depth camera assembly, a structured light emitter and/or detector, or any combination thereof. In some embodiments, augmented-reality system 1100 may or may not include sensor 1140 or may include more than one sensor. In embodiments in which sensor 1140 includes an IMU, the IMU may generate calibration data based on measurement signals from sensor 1140. Examples of sensor 1140 may include, without limitation, accelerometers, gyroscopes, magnetometers, other suitable types of sensors that detect motion, sensors used for error correction of the IMU, or some combination thereof.

In some examples, augmented-reality system 1100 may also include a microphone array with a plurality of acoustic transducers 1120(A)-1120(J), referred to collectively as acoustic transducers 1120. Acoustic transducers 1120 may represent transducers that detect air pressure variations induced by sound waves. Each acoustic transducer 1120 may be configured to detect sound and convert the detected sound into an electronic format (e.g., an analog or digital format). The microphone array in FIG. 11 may include, for example, ten acoustic transducers: 1120(A) and 1120(B), which may be designed to be placed inside a corresponding ear of the user, acoustic transducers 1120(C), 1120(D), 1120(E), 1120(F), 1120(G), and 1120(H), which may be positioned at various locations on frame 1110, and/or acoustic transducers 1120(I) and 1120(J), which may be positioned on a corresponding neckband 1105.

In some embodiments, one or more of acoustic transducers 1120(A)-(J) may be used as output transducers (e.g., speakers). For example, acoustic transducers 1120(A) and/or 1120(B) may be earbuds or any other suitable type of headphone or speaker.

The configuration of acoustic transducers 1120 of the microphone array may vary. While augmented-reality system 1100 is shown in FIG. 11 as having ten acoustic transducers 1120, the number of acoustic transducers 1120 may be greater or less than ten. In some embodiments, using higher numbers of acoustic transducers 1120 may increase the amount of audio information collected and/or the sensitivity and accuracy of the audio information. In contrast, using a lower number of acoustic transducers 1120 may decrease the computing power required by an associated controller 1150 to process the collected audio information. In addition, the position of each acoustic transducer 1120 of the microphone array may vary. For example, the position of an acoustic transducer 1120 may include a defined position on the user, a defined coordinate on frame 1110, an orientation associated with each acoustic transducer 1120, or some combination thereof.

Acoustic transducers 1120(A) and 1120(B) may be positioned on different parts of the user's ear, such as behind the pinna, behind the tragus, and/or within the auricle or fossa. Or, there may be additional acoustic transducers 1120 on or surrounding the ear in addition to acoustic transducers 1120 inside the ear canal. Having an acoustic transducer 1120 positioned next to an ear canal of a user may enable the microphone array to collect information on how sounds arrive at the ear canal. By positioning at least two of acoustic transducers 1120 on either side of a user's head (e.g., as binaural microphones), AR system 1100 may simulate binaural hearing and capture a 3D stereo sound field around about a user's head. In some embodiments, acoustic transducers 1120(A) and 1120(B) may be connected to augmented-reality system 1100 via a wired connection 1130, and in other embodiments acoustic transducers 1120(A) and 1120(B) may be connected to augmented-reality system 1100 via a wireless connection (e.g., a BLUETOOTH connection). In still other embodiments, acoustic transducers 1120(A) and 1120(B) may not be used at all in conjunction with augmented-reality system 1100.

Acoustic transducers 1120 on frame 1110 may be positioned in a variety of different ways, including along the length of the temples, across the bridge, above or below display devices 1115(A) and 1115(B), or some combination thereof. Acoustic transducers 1120 may also be oriented such that the microphone array is able to detect sounds in a wide range of directions surrounding the user wearing the augmented-reality system 1100. In some embodiments, an optimization process may be performed during manufacturing of augmented-reality system 1100 to determine relative positioning of each acoustic transducer 1120 in the microphone array.

In some examples, augmented-reality system 1100 may include or be connected to an external device (e.g., a paired device), such as neckband 1105. Neckband 1105 generally represents any type or form of paired device. Thus, the following discussion of neckband 1105 may also apply to various other paired devices, such as charging cases, smart watches, smart phones, wrist bands, other wearable devices, hand-held controllers, tablet computers, laptop computers, other external compute devices, etc.

As shown, neckband 1105 may be coupled to eyewear device 1102 via one or more connectors. The connectors may be wired or wireless and may include electrical and/or non-electrical (e.g., structural) components. In some cases, eyewear device 1102 and neckband 1105 may operate independently without any wired or wireless connection between them. While FIG. 11 illustrates the components of eyewear device 1102 and neckband 1105 in example locations on eyewear device 1102 and neckband 1105, the components may be located elsewhere and/or distributed differently on eyewear device 1102 and/or neckband 1105. In some embodiments, the components of eyewear device 1102 and neckband 1105 may be located on one or more additional peripheral devices paired with eyewear device 1102, neckband 1105, or some combination thereof.

Pairing external devices, such as neckband 1105, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 1100 may be provided by a paired device or shared between a paired device and an eyewear device, thus reducing the weight, heat profile, and form factor of the eyewear device overall while still retaining desired functionality. For example, neckband 1105 may allow components that would otherwise be included on an eyewear device to be included in neckband 1105 since users may tolerate a heavier weight load on their shoulders than they would tolerate on their heads. Neckband 1105 may also have a larger surface area over which to diffuse and disperse heat to the ambient environment. Thus, neckband 1105 may allow for greater battery and computation capacity than might otherwise have been possible on a stand-alone eyewear device. Since weight carried in neckband 1105 may be less invasive to a user than weight carried in eyewear device 1102, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 1105 may be communicatively coupled with eyewear device 1102 and/or to other devices. These other devices may provide certain functions (e.g., tracking, localizing, depth mapping, processing, storage, etc.) to augmented-reality system 1100. In the embodiment of FIG. 11, neckband 1105 may include two acoustic transducers (e.g., 1120(I) and 1120(J)) that are part of the microphone array (or potentially form their own microphone subarray). Neckband 1105 may also include a controller 1125 and a power source 1135.

Acoustic transducers 1120(I) and 1120(J) of neckband 1105 may be configured to detect sound and convert the detected sound into an electronic format (analog or digital). In the embodiment of FIG. 11, acoustic transducers 1120(I) and 1120(J) may be positioned on neckband 1105, thereby increasing the distance between the neckband acoustic transducers 1120(I) and 1120(J) and other acoustic transducers 1120 positioned on eyewear device 1102. In some cases, increasing the distance between acoustic transducers 1120 of the microphone array may improve the accuracy of beamforming performed via the microphone array. For example, if a sound is detected by acoustic transducers 1120(C) and 1120(D) and the distance between acoustic transducers 1120(C) and 1120(D) is greater than, e.g., the distance between acoustic transducers 1120(D) and 1120(E), the determined source location of the detected sound may be more accurate than if the sound had been detected by acoustic transducers 1120(D) and 1120(E).

Controller 1125 of neckband 1105 may process information generated by the sensors on neckband 1105 and/or augmented-reality system 1100. For example, controller 1125 may process information from the microphone array that describes sounds detected by the microphone array. For each detected sound, controller 1125 may perform a direction-of-arrival (DOA) estimation to estimate a direction from which the detected sound arrived at the microphone array. As the microphone array detects sounds, controller 1125 may populate an audio data set with the information. In embodiments in which augmented-reality system 1100 includes an inertial measurement unit, controller 1125 may compute all inertial and spatial calculations from the IMU located on eyewear device 1102. A connector may convey information between augmented-reality system 1100 and neckband 1105 and between augmented-reality system 1100 and controller 1125. The information may be in the form of optical data, electrical data, wireless data, or any other transmittable data form. Moving the processing of information generated by augmented-reality system 1100 to neckband 1105 may reduce weight and heat in eyewear device 1102, making it more comfortable to the user.

Power source 1135 in neckband 1105 may provide power to eyewear device 1102 and/or to neckband 1105. Power source 1135 may include, without limitation, lithium-ion batteries, lithium-polymer batteries, primary lithium batteries, alkaline batteries, or any other form of power storage. In some cases, power source 1135 may be a wired power source. Including power source 1135 on neckband 1105 instead of on eyewear device 1102 may help better distribute the weight and heat generated by power source 1135.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 1200 in FIG. 12, that mostly or completely covers a user's field of view. Virtual-reality system 1200 may include a front rigid body 1202 and a band 1204 shaped to fit around a user's head. Virtual-reality system 1200 may also include output audio transducers 1206(A) and 1206(B). Furthermore, while not shown in FIG. 12, front rigid body 1202 may include one or more electronic elements, including one or more electronic displays, one or more inertial measurement units (IMUs), one or more tracking emitters or detectors, and/or any other suitable device or system for creating an artificial-reality experience.

Artificial-reality systems may include a variety of types of visual feedback mechanisms. For example, display devices in augmented-reality system 1100 and/or virtual-reality system 1200 may include one or more liquid crystal displays (LCDs), light emitting diode (LED) displays, microLED displays, organic LED (OLED) displays, digital light project (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 1100 and/or virtual-reality system 1200 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 1100 and/or virtual-reality system 1200 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference may be made to any claims appended hereto and their equivalents in determining the scope of the present disclosure.

Unless otherwise noted, the terms “connected to” and “coupled to” (and their derivatives), as used in the specification and/or claims, are to be construed as permitting both direct and indirect (i.e., via other elements or components) connection. In addition, the terms “a” or “an,” as used in the specification and/or claims, are to be construed as meaning “at least one of.” Finally, for ease of use, the terms “including” and “having” (and their derivatives), as used in the specification and/or claims, are interchangeable with and have the same meaning as the word “comprising.”

1. An eyewear device comprising:
a temple that comprises an at least partial cavity;
a circuit board placed inside the at least partial cavity of the temple;
a high-band antenna and a low-band antenna that are:
distinct and provided separately from one another;
placed inside the at least partial cavity of the temple;
commutatively coupled to the circuit board; and
offset from the circuit board;
a radio-frequency feed communicatively coupled between the high-band antenna and the circuit board; and
an additional radio-frequency feed communicatively coupled between the low-band antenna and the circuit board, wherein the radio-frequently feed and the additional radio-frequency feed are distinct and provided separately from one another.

2. The eyewear device of claim 1, wherein the high-band antenna and the low-band antenna are secured to the circuit board by one or more fasteners.

3. The eyewear device of claim 2, wherein the one or more fasteners comprise one or more spring clips that serve as one or more shorting lines for the high-band antenna or the low-band antenna.

4. The eyewear device of claim 2, wherein the one or more fasteners comprise a spring clip that supports both the high-band antenna and the low-band antenna simultaneously.

5. (canceled)

6. The eyewear device of claim 2, wherein the radio-frequency feed or the additional radio-frequency feed is positioned proximate to the one or more fasteners.

7. The eyewear device of claim 1, further comprising:
a plurality of batteries; and
an additional temple that comprises at least a partial cavity; and
wherein one of the plurality of batteries is placed inside the at least partial cavity of the temple and another one of the plurality of batteries is placed inside the at least partial cavity of the additional temple.

8. The eyewear device of claim 7, further comprising an additional circuit board that is placed inside the at least partial cavity of the additional temple.

9. The eyewear device of claim 1, wherein the high-band antenna or the low-band antenna comprises at least one flex antenna.

10. The eyewear device of claim 1, wherein the high-band antenna or the low-band antenna is offset from the circuit board by a distance of between one millimeter and two millimeters.

11. The eyewear device of claim 1, wherein the high-band antenna or the low-band antenna is secured to an inner wall of the temple.

12. The eyewear device of claim 1, wherein the high-band antenna and the low-band antenna collectively support:
a 2.4 gigahertz band;
a 5 gigahertz band;
a 6 gigahertz band; and
a 7 gigahertz band.

13. An artificial-reality system comprising:
a temple of an eyewear frame that comprises an at least partial cavity;
a circuit board placed inside the at least partial cavity of the temple;
a high-band antenna and a low-band antenna that are:
distinct and provided separately from one another;
placed inside the at least partial cavity of the temple;
commutatively coupled to the circuit board; and
offset from the circuit board;
a radio-frequency feed communicatively coupled between the high-band antenna and the circuit board;
an additional radio-frequency feed communicatively coupled between the low-band antenna and the circuit board, wherein the radio-frequently feed and the additional radio-frequency feed are distinct and provided separately from one another; and
at least one see-through optical element that facilitates viewing both a physical environment of a user and a virtual object.

14. The artificial-reality system of claim 13, wherein the high-band antenna and the low-band antenna are secured to the circuit board by one or more fasteners.

15. The artificial-reality system of claim 14, wherein the one or more fasteners comprise one or more spring clips that serve as one or more shorting lines for the high-band antenna or the low-band antenna.

16. The artificial-reality system of claim 14, wherein the one or more fasteners comprise a spring clip that supports both the high-band antenna and the low-band antenna simultaneously.

17. (canceled)

18. The artificial-reality system of claim 14, wherein the radio-frequency feed or the additional radio-frequency feed is positioned proximate to the one or more fasteners.

19. The artificial-reality system of claim 13, further comprising:
a plurality of batteries; and
an additional temple that comprises at least a partial cavity; and
wherein one of the plurality of batteries is placed inside the at least partial cavity of the temple and another one of the plurality of batteries is placed inside the at least partial cavity of the additional temple.

20. A method comprising:
placing a circuit board inside an at least partial cavity formed in a temple of an eyewear device;
communicatively coupling a high-band antenna and a low-band antenna to the circuit board, wherein the high-band antenna and the low-band antenna are distinct and provided separately from one another;
placing the at least one antenna inside the at least partial cavity formed in the temple;
offsetting the at least one antenna from the circuit board;
communicatively coupling a radio-frequency feed between the high-band antenna and the circuit board; and
communicatively coupling an additional radio-frequency feed between the low-band antenna and the circuit board, wherein the radio-frequently feed and the additional radio-frequency feed are distinct and provided separately from one another.
